(19) United States
(12) Patent Application Publication
(10) Pub. No.: US 2009/0204037 A1
(43) Pub. Date: Aug. 13, 2009

(54) Compression Apparatus for Applying Intermittent Pressure to the Leg

(76) Inventor: Sundaram Ravikumar, Briarcliff Manor, NY (US)

Correspondence Address: GORDON & JACOBSON, P.C., 60 LONG RIDGE ROAD, SUITE 407, STAMFORD, CT, 06902, US

(21) Appl. No.: 12/029,668

(22) Filed: Feb. 12, 2008

(51) Int. Cl. A61H 7/00

(52) U.S. Cl. 601/152; 601/151

(57) ABSTRACT

An apparatus applies pressure to a portion of the human body using two fluidly coupled pressurized members. The apparatus includes fluidly coupled foot and leg bladders, each having an inflatable chamber accommodating an entering fluid. Optional straps locate the bladders to portions of the body such as a leg and the bottom of a foot, whereby the apparatus is operated through the walking motion. The foot bladder deflates as the heel strikes the ground, thereby forcing fluid out of the foot bladder, through a fluid conduit, and into the leg bladder, which raises the pressure therein. When the heel is raised, some fluid is forced out of the leg bladder, back through the conduit, and into the foot bladder. This process repeats as a person walks, which creates a pumping or kneading force on the leg, thereby promoting blood flow, drainage, treatment, and healing.

### BACKGROUND OF THE INVENTION

1. Field of the Invention

This invention relates broadly to a medical apparatus. More particularly, this invention relates to mechanisms for applying intermittent pressure to a leg in conjunction with the treatment of venous ulcers of the leg, although it is not limited thereto.

2. State of the Art

A venous ulcer is manifest damage and loss of skin above the ankle that is the result of a problem with the veins in the leg. Venous ulcers typically develop on either side of the lower leg, above the ankle and below the calf. They are difficult to heal and often recur.

The veins of the leg are divided into the superficial and deep systems according to their position relative to the fascia. The deep veins, which come together to form the popliteal and femoral veins lie within the fascia and are responsible for the venous return from the leg muscles. Dilated valve less sinusoids also lie within the fascia (more particularly in the soleus and gastrocnemius muscles). The sinusoids fill with blood when the leg is at rest.

The major vessels of the superficial venous system are the long saphenous vein, which runs along the medial side of the leg from foot to groin, and the short saphenous vein, which runs at the back of the calf from foot to knee. These vessels lie outside the fascia and are responsible for the venous return from the skin and subcutaneous fat.

Communicating veins, sometimes called perforators because they perforate the deep fascia, join the two systems. The perforators, like the other veins in the leg, contain valves that permit the flow of blood in one direction only, from the outer or superficial system inwards to the deep veins.

The venous pressure at the ankle of a subject who is lying supine is around 10 mmHg. Upon standing, the venous pressure will rise considerably due to an increase in hydrostatic pressure (equivalent to the weight of a vertical column of blood stretching from the point of measurement to the right auricle of the heart).

During walking, as the foot is dorsally flexed, the contraction of the calf muscle compresses the deep veins and soleal sinuses thereby emptying them of blood. As the foot is plantarly flexed, the pressure in the veins falls, the proximal valves close, and the veins are refilled by blood passing through the perforators from the superficial system. During this cycle, in a normal leg, the distal valves of the deep veins and the valves of the perforators will ensure that the expelled blood can go in only one direction-upwards, back to the heart.

Blockage or damage to the venous system will cause disruption to normal blood flow, which may manifest itself in a number of different ways according to the site and extent of the damage. If the valves in the superficial system are affected, venous return will be impaired and blood may accumulate in the veins causing them to become distended, leading to the formation of varicosities (varicose veins). If the function of the perforator valves is impaired, the action of the calf muscle pump will tend to cause blood to flow in the reverse direction into the superficial system increasing the possibility of damage to the superficial vessels.

Following a deep vein thrombosis that results in complete or partial obstruction of a deep vein, the unrelieved pressure produced by the calf muscle pump on the perforator valves may cause these to become incompetent. If this occurs, there will be a large rise in the pressure in the superficial system, which may force proteins and red cells out of the capillaries and into the surrounding tissue. Here, the red cells break down releasing a red pigment that causes staining of the skin, an early indicator of possible ulcer formation.

Venous leg ulcers are generally shallow and red in color. The skin surrounding the ulcer is frequently discolored due to the staining described previously. Incompetent perforating vein valves can also cause malleolar venules to become dilated and appear as fine red threads around the ankle. This condition, called ankle flair, is also diagnostic of a venous ulcer.

For patients with venous disease, the application of external compression can help to minimize or reverse the skin and vascular changes described previously, by forcing fluid from the interstitial spaces back into the vascular and lymphatic compartments.

Medical hosiery represents a useful and convenient method of applying compression to normal shaped legs in order to prevent the development or recurrence of leg ulcers. However, these stockings are of limited value in the treatment of active ulceration, being difficult to apply over dressings. In such situations compression bandages currently represent the treatment of choice. Compression bandages apply a pressure to the limb that is directly proportional to bandage tension but inversely proportional to the radius of curvature of the limb to which it is applied. This means, therefore, that a bandage applied with constant tension to a limb of normal proportions will automatically produce graduated compression with the highest pressure at the ankle. This pressure will gradually reduce up the leg as the circumference increases.

As can be readily appreciated, it is cumbersome and difficult to apply uniform tension to the compression bandage as it is applied to the treated limb, and thus this is accomplished only by highly skilled caregivers. Moreover, once secured to the treated limb, care and attention must be given to ensure that the bandage does not slip or become displaced as this will lead to multiple layers forming, which in turn may lead to localized areas of high pressure, which can place the patient in direct risk of skin necrosis.

Mechanical compression treatments have also been proposed. An exemplary compression device is described in U.S. Pat. No. 5,031,604 to Dye. As generally described at col. 2, lines 33 et seq., an arrangement of chambers are provided that circumscribe the leg. An active pneumatic control system controls the pressure in the chambers to squeeze the leg near the ankle and then squeeze sequentially upward toward the knee in order to move blood from the extremity toward the heart. As noted in col. 4, lines 20-59 of U.S. Pat. No. 6,488,643 to Tumey et al., the mechanically produced compression levels may produce ischaemic (i.e., localized tissue anemia) not noted at similar compression levels obtained through bandaging. It may also produce cuffing (i.e., a reduction in leg pulsatile blood flow). The pneumatic control system is also bulky and heavy, which severely limits the mobility of the patient during treatment. Moreover, the pneumatic control system fails to provide a mechanism to ensure that excessive pressure, which can cause necrosis, is not applied to the treated limb. These limitations have resulted in most mechanical compression devices being contraindicated for patients exhibiting deep-vein thrombosis. Consequently, those skilled in the art have to date avoided such mechanical compression devices for the treatment of venous ulcers or edema of the extremities.

Co-owned U.S. Publication No. 2004/0193084, which is hereby incorporated by reference herein in its entirety, discloses a device for applying pressure to the human leg for use in conjunction with treatment of varicose veins. The device includes a flexible member and at least one air bladder chamber integral thereto that are adapted to securely wrap around the human leg. A tube in fluid communication with the air bladder chamber(s) extends to an air pumping mechanism that operates to inflate the air bladder chamber(s) to a pressurized state. The flexible member preferably includes an opening at the knee joint level to enable a patella to protrude therethrough. In addition, the flexible member preferably extends below knee joint level and is adapted to securely wrap around a lower portion of a leg to provide stability to the leg. Preferably, the air bladder chamber of the device is substantially longer in a first dimension than in a second dimension orthogonal thereto such that the air bladder chamber can be positioned to cover a portion of the human leg that is relatively long in the vertical dimension and narrow in the horizontal dimension.

Co-owned U.S. Pat. No. 7,276,037, which is hereby incorporated by reference herein in its entirety, discloses an apparatus for applying compression therapy to an extremity of the human body, such as a portion of the human leg. The device includes a flexible member and an air bladder chamber. The flexible member is adapted to wrap around the extremity to secure the air bladder chamber to the extremity. An air pumping mechanism is operated to inflate the air bladder chamber to a pressurized state. One or more fluid-filled pressurized members are provided, each separate and distinct from the flexible member and the air bladder chamber and thus readily moveable relative to the flexible member and the air bladder chamber. The pressurized member(s) is operably disposed between the extremity and the flexible member whereby it applies increased localized pressure to the extremity during use. Preferably, the air bladder chamber is substantially longer in a first dimension than in a second dimension orthogonal thereto such that it can extend longitudinally along the extremity to cover a relatively long and narrow portion of the extremity. The position of the air chamber can be readily adapted to apply local pressure to desired body parts (such as a certain venous channel). The pressurized member(s) can be positioned during use such that it covers a venous ulcer (or other treatment sites) and applies increased localized pressure to the treatment site in order to promote healing.

### SUMMARY OF THE INVENTION

An apparatus is provided for applying intermittent pressure to a portion of the human body, such as an area of the human leg, which assists with the healing and treatment of various conditions such as venous ulcers or wounds by promoting blood flow into and out of the area and by increasing drainage. The apparatus includes a foot bladder and a leg bladder, each having inflatable chambers that accommodate an entering fluid by inflating. The bladders are fluidly coupled by a fluid conduit, and each is preferably equipped with a means for locating it on a portion of the body. In the preferred embodiment, the foot bladder is positioned on a bottom of a foot and the leg bladder is positioned on a lower portion of a leg. As a person walks while wearing the apparatus, a portion of the foot bladder deflates as the person's foot (heel) strikes the ground due to the external pressure placed on the foot bladder, thereby forcing fluid out of the foot bladder, through the fluid conduit, and into the leg bladder, which raises the pressure therein. As the person's foot rolls from heel to toe in the standard walking motion, the external pressure from the person's weight is removed from the foot bladder, resulting in the pressure of the leg bladder being higher than the pressure in the foot bladder. Fluid thus flows back through the fluid conduit and into the foot bladder, which then inflates again to its original state, such that the pressures of the foot bladder and leg bladder are equalized. This process repeats as a person walks, thereby creating a pumping or kneading force on the leg as the pressure in the leg bladder intermittently increases and decreases, thereby promoting blood flow, fluid drainage, treatment, and healing to various parts of the leg.

### BRIEF DESCRIPTION OF THE DRAWINGS

FIG. 1 is a diagram of a compression apparatus of the present invention wherein a leg bladder and a foot bladder are fluidly connected by a fluid conduit.

FIG. 2A is a perspective view of the leg bladder.

FIG. 2B is a top view of the leg bladder of FIG. 2A.

FIG. 2C is a side section view of the leg bladder of FIG. 2A.

FIG. 2D is a diagram of the leg bladder of FIG. 2A secured to a portion of a leg with horizontally positioned straps.

FIG. 2E is a diagram of the fluid leg bladder of FIG. 2A secured to a portion of a leg with crisscrossing straps.

FIG. 3A is a top view of the foot bladder of FIG. 1 in a flat configuration.

FIG. 3B is a partially sectioned perspective view of the foot bladder of FIG. 3A.

FIG. 3C is a side partially sectioned perspective view of the foot bladder of FIG. 3B in a bent configuration.

FIG. 3D is a top view of an alternative shape of a foot bladder.

FIG. 3E is a top view of a second alternative shape of a foot bladder.

FIG. 3F is a top view of the foot bladder of FIG. 3E with straps containing adhesive ends for securing the foot bladder to a portion of a foot.

FIG. 3G is a side view of the foot bladder of FIG. 3F secured to the heel of a foot.

FIG. 4 is a side view of an embodiment of the invention showing the foot bladder positioned on a heel of a foot and the leg bladder positioned about a lower portion of a leg.

FIG. 5 is a schematic view of the invention showing the foot and leg bladders, the fluid conduit, and a one way valve connected to the fluid conduit.

FIG. 6A is a diagram of a flexible member and air bladder chamber for use with the compression apparatus of the present invention.

FIG. 6B is a perspective view of the flexible member of FIG. 6A wrapped around a leg.

FIG. 6C is a partially cut-away perspective view of the flexible member of FIG. 6A wrapped around a leg with the leg bladder sandwiched between the leg and the flexible member.

### DETAILED DESCRIPTION OF THE PREFERRED EMBODIMENTS

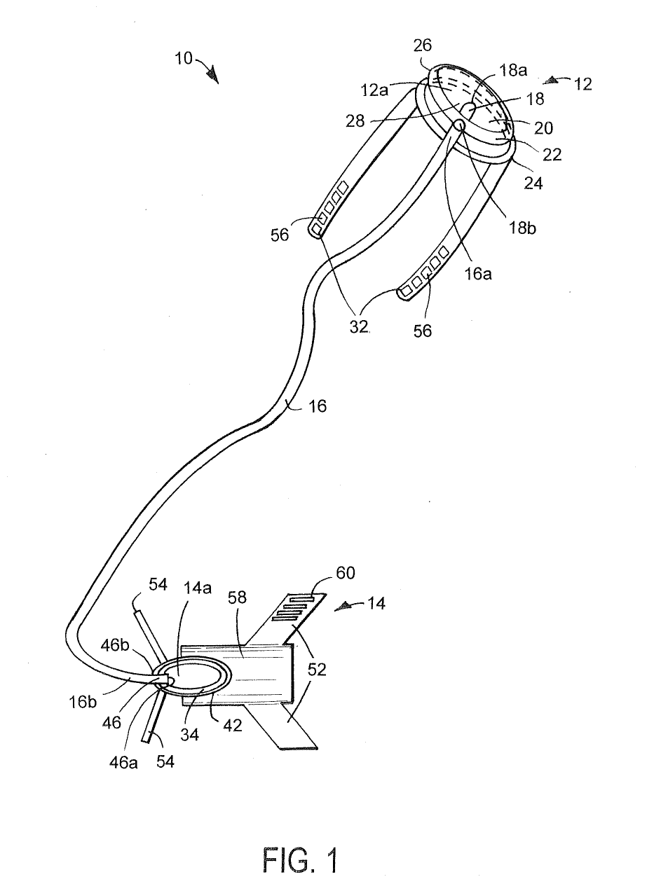

Turning to FIG. 1, shown is an apparatus 10 for providing intermittent pressure to a portion of a human body, such as a leg, which promotes blood flow and fluid drainage to treat various conditions, including venous ulcers or wounds. The apparatus utilizes a leg bladder 12 and a foot bladder 14, each having inflatable chambers 12a, 14a that accommodate an entering fluid by inflating. The bladders 12, 14 are fluidly coupled by a fluid conduit 16, which attaches to the leg bladder 12 and the foot bladder 14 at respective ends 16a, 16b, thereby allowing fluid to flow back and forth between the leg bladder 12 and the foot bladder 14. The intermittent deflation of one of the two bladders 12, 14 causes an intermittent inflation and pressure increase in the other of the two bladders 12, 14 as described in the preferred and alternative embodiments further discussed below.

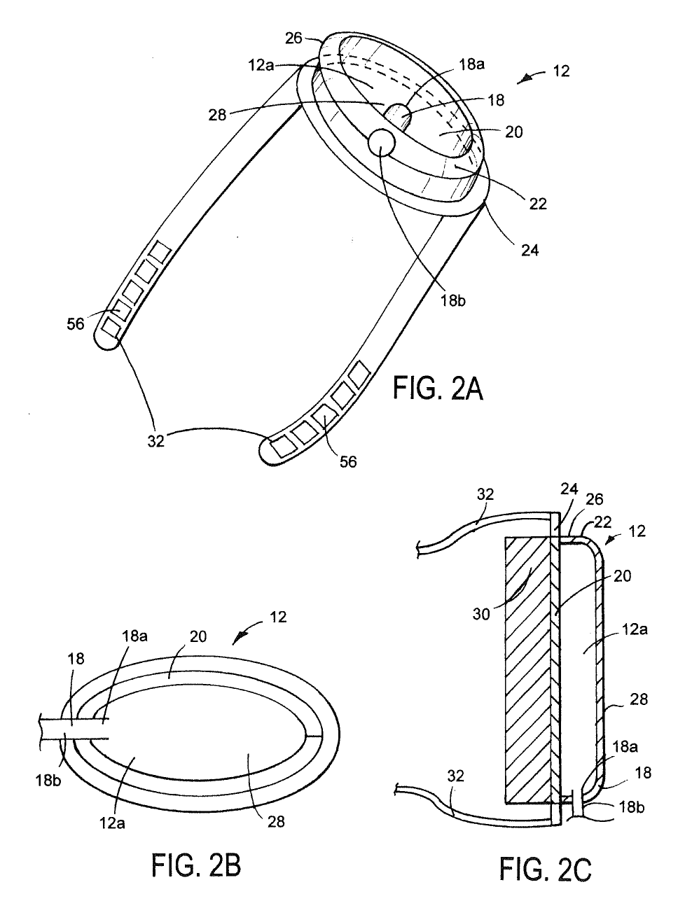

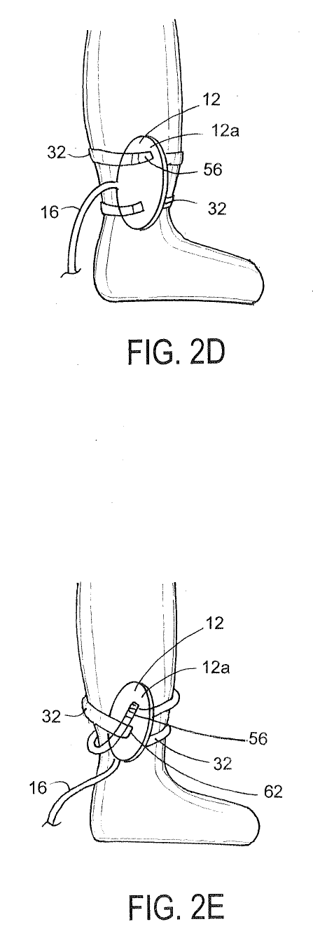

The leg bladder 12 is best seen with reference to FIGS. 2A-2E. The leg bladder 12 has a lower wall 20 and an upper wall 22 bonded together, preferably by heat sealing, on a flange portion 24 of the lower wall 20. The lower wall 20 and the upper wall 22 define the inflatable chamber 12a therebetween. The upper wall 22 extends orthogonally from the flange portion 24 to form a sidewall 26, and then curves to form a top wall 28 which is generally parallel to the lower wall 20. The lower wall 20 including the flange portion 24, and the upper wall 22 are flexible such that the lower wall 20 may bend to conform to a surface contour of a leg. A bottom layer 30 of material is optionally provided on the lower wall 20 of the leg bladder 12. The bottom layer 30 is preferably a semi-permeable material (e.g., a sponge) that absorbs sweat, puss, or other fluids and provides a more delicate contact surface to the wound. If desired, an adhesive film may be provided on the flange portion 24 to help secure the leg bladder 12 to the leg.

In one embodiment, the leg bladder 12 has a nozzle or connector element 18 extending through the upper wall 22 with a first end 18a inside the inflatable chamber 12a and a second end 18b outside of the inflatable chamber 12a. The nozzle 18 receives the fluid conduit 16 at the first end 16a of the fluid conduit 16 (FIG. 1). The second end 18b of the nozzle 18 may alternatively be located flush with the sidewall 26 rather than outside of the inflatable chamber 12a so long as an airtight seal is provided between the nozzle 18 and the upper wall 22. The nozzle is preferably provided with an internal valve (not shown) which is open so long as the fluid conduit 16 is inserted in the nozzle 18, but which closes and prevents fluid from escaping when the fluid conduit 16 is removed from the nozzle 18. As shown in FIG. 2C, the nozzle 18 preferably extends through the sidewall 26 portion of the upper wall 22 parallel with the lower wall 20 so that when the leg bladder 12 is placed over a wound on a leg, the nozzle 18 extends in a direction principally parallel with a surface of the leg. Providing the nozzle 18 parallel with the surface of the leg will prevent it from creating a bulge or protrusion orthogonal to the surface of the leg, which may create additional pressure on the region of the leg directly underneath the nozzle 18 when the leg bladder 12 is attached to the leg as further discussed below. In addition, maintaining the nozzle 18 parallel with the surface of the leg will facilitate the attachment of the fluid conduit 16 with the leg bladder 12 in a direction principally parallel with the surface of the leg, a configuration that more readily allows clothing to be worn over the leg bladder 12.

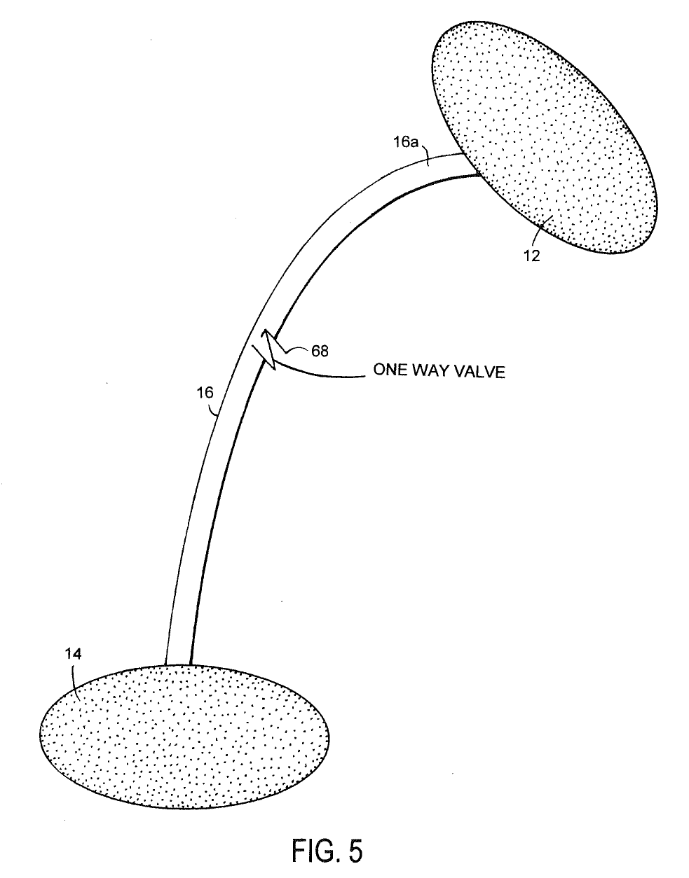

In another embodiment, shown in FIG. 5, the leg bladder 12 does not contain a nozzle 18. Instead, the first end 16a of the fluid conduit 16 is integrally formed with the leg bladder 12 such that the fluid conduit 16 is inseparable from the leg bladder 12. An optional one-way valve 68 is provided as described below. If not provided, then the system is a closed system that is pressurized during a manufacturing process, and thus does not require the leg bladder 12 or any other component of the apparatus 10 to be pressurized prior to its operation.

Referring to FIGS. 2A-2E, the leg bladder 12 is optionally equipped with a plurality of straps 32 which are designed to extend around the leg in order to secure the leg bladder 12 to a bottom portion of the leg. The straps 32 may contain Velcro sections 56 (FIG. 2A) that overlap and attach to each other after wrapping around the leg. The straps 32 may also have an elastic quality to produce axially directed compression forces when they are wrapped around the leg. In one embodiment, the straps 32 are wrapped with tension over the inflatable chamber 12a after passing around the leg such that when the Velcro sections 56 are connected, the straps 32 exert a continuous compressive force on the inflatable chamber 12a. The straps 32 may be secured horizontally around the leg (FIG. 2D) or crisscrossed over the leg bladder 12 (FIG. 2E) to secure the leg bladder 12 to the leg and to provide resistance to the inflatable chamber 12a inflating outward, thus increasing the pressure on the wound area when additional fluid is forced into the inflatable chamber 12a as further discussed below.

The lower wall 20, upper wall 22, and bottom layer 30 of the fluid leg bladder 12 may be formed in a variety of shapes and from a variety of materials, but flexible plastic or rubber is preferred so that the fluid leg bladder 12 may bend to accommodate the specific contour and curves of a given leg. The size of the leg bladder 12 may be varied, and different sizes may be chosen depending on the size and location of the wound. The upper wall 22 of the fluid leg bladder 12 is preferably made from a material such as a flexible and resilient plastic (e.g., polyurethane, polyvinylchloride (PVC), or polypropylene) that changes shape in order to permit the volume of the inflatable chamber 12a to increase as additional fluid enters therein. The material of the upper wall 22 should be non-rigid so that as pressure increases inside the inflatable chamber 12a, the pressure is not absorbed by the upper wall 22, but rather, is transmitted through the wall to the leg. The operation of the leg bladder 12 as part of the overall apparatus 10 is discussed in more detail below.

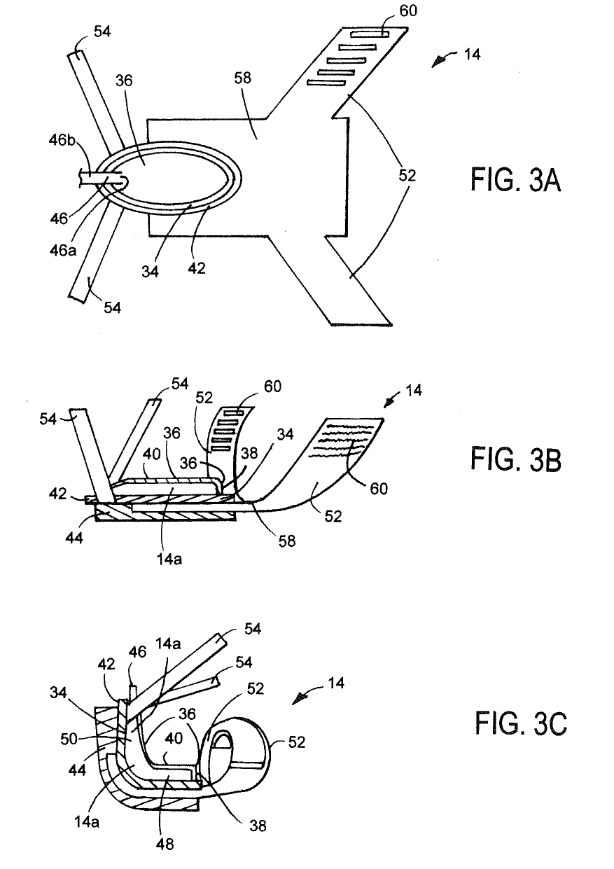

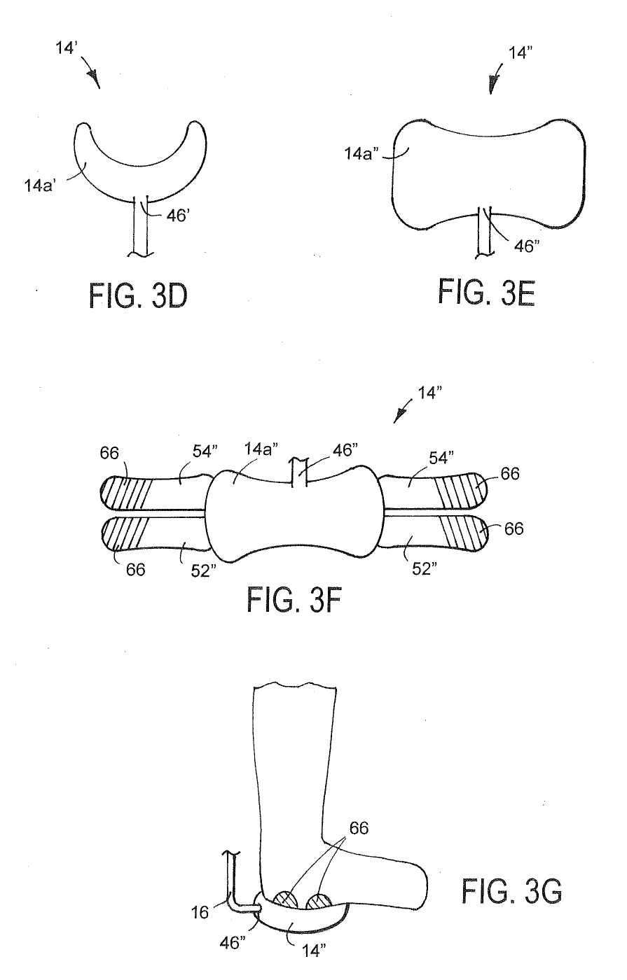

The fluid foot bladder 14 is best seen with reference to FIGS. 3A-3C. The foot bladder 14 has a lower wall 34 with a flange 42, and an upper wall 36 that forms a sidewall 38 and a top wall 40. The fluid foot bladder 14 may be formed in the same manner as the leg bladder 12. The lower wall 34 and upper wall 36 are bonded together, preferably by heat sealing on the flange 42 of the lower wall 34. The upper wall 36 and lower wall 34 define the inflatable chamber 14a. The upper wall 36 extends orthogonally from the flange 42 to form the sidewall 38 and curves to form the top wall 40, which is generally parallel to the lower wall 34. The lower wall 34, including the flange 42 and the upper wall 36 are flexible such that the lower wall 34 may bend to conform to a surface contour of an ankle.

In one embodiment, the foot bladder 14 is worn in a bent configuration (FIG. 3C) that conforms to the heel. The size and shape of the inflatable chamber 14a of the foot bladder 14 may vary significantly, and is by way of example and not limitation between about three and six inches long, about one and a half to three inches wide, and when inflated between about one quarter and one half inch in height. The shape of the inflatable chamber 14 preferably conforms to the shape of a foot or heel. A bottom layer 44 of material is optionally provided to the lower wall 34 of the foot bladder 14. If the fluid foot bladder 14 is worn without any footwear covering it, then the bottom layer 44 may provide added cushioning for the heel and/or may provide a non-slip surface having a higher coefficient of static friction than the lower wall 34. The fluid foot bladder 14 may also be worn upside down wherein the inflatable chamber 14a is operably disposed on the exterior thereof, and the bottom layer 44 is disposed on the interior thereof in direct contact with the heel. The bottom layer 30 is optional in either of these configurations as the primary function of the foot bladder 14, as discussed in further detail below, is to pump fluid into the leg bladder 12 and receive fluid back from the leg bladder 12 during the normal walking motion.

In one embodiment, the foot bladder 14 has a nozzle or connector element 46 extending through the upper wall 36 with a first end 46a inside the inflatable chamber 14a, and a second end 46b outside of the inflatable chamber 14a. The nozzle 46 receives the fluid conduit 16 at the second end 16b of the fluid conduit 16 (FIG. 1). The nozzle 46 is preferably provided with an internal valve (not shown) which is open so long as the fluid conduit 16 is inserted in the nozzle 46, but which closes and prevents fluid from escaping when the fluid conduit 16 is removed from the nozzle 46. The nozzle 46 preferably extends through the sidewall 38 portion of the upper wall 36 parallel with the lower wall 34 so that when the foot bladder 14 is bent into the configuration shown in FIG. 3C, the nozzle 46 extends in an upward direction principally parallel with the back of the leg.

In another embodiment, shown in FIG. 5, the foot bladder 14 does not contain a nozzle 46. Instead, the second end 16b of the fluid conduit 16 is integrally formed with the foot bladder 14 such that the fluid conduit 16 is inseparable from the foot bladder 12. As described above, an optional one-way valve 68 is provided as described below. If not provided, then the system is a closed system that is pressurized during a manufacturing process, and thus does not require the foot bladder 14 or any other component of the apparatus 10 to be pressurized prior to its operation.

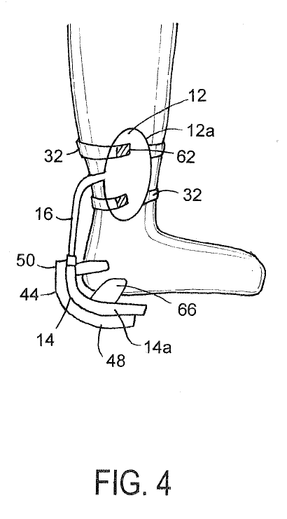

In the bent configuration shown in FIG. 3C, the inflatable chamber 14a of the foot bladder 14 can be described as being divided into a compression section 48 and a connecting section 50. As the foot bladder 14 is attached to a heel of a foot (further discussed below), the compression section 48 of the inflatable chamber 14a is operably disposed directly beneath the heel while the connecting section 50 is oriented in a direction principally parallel with the direction of the leg (FIG. 4). Positioning the nozzle 46 such that it extends in the direction of the connecting section 50 perpendicular to the compression section 48 prevents the nozzle 46 from being compressed as a user steps down on the compression section 48 while walking. In addition, positioning the nozzle 46 in a direction perpendicular to the compression section 48 allows the fluid conduit 16 to attach to the foot bladder 14 parallel with the leg and prevents the fluid conduit 16 from being compressed by the ankle or leg while a person is walking.

The foot bladder 14 is preferably equipped with at least two front and/or rear straps 52, 54 which wrap around the foot to secure the fluid foot bladder 14 to a bottom portion of the foot. The straps 52, 54 preferably include Velcro sections 60 that overlap and attach to each other after wrapping around the foot. The front straps 52 extend from a front flap 58 that is attached to the lower wall 34 or flange 42 of the foot bladder 36 by heat seal, glue, stitching, or other equivalent means. The front straps 52 extend away from the front flap 58. The rear straps 54 connect directly to either the flange 42 or the lower wall 34 of the foot bladder 14 by heat sealing, glue, stitching, or other equivalent means. The rear straps 54 start at a rear portion of the foot bladder 14 and may be pulled up towards the top of the foot in front of the leg, and wrapped over the top of the foot. The rear straps 54 also have Velcro sections (not shown) that overlap and attach to each other on the top of the foot. In one embodiment, the front and rear straps 52, 54 are wrapped with tension over the top of the foot such that a continuous compressive force is exerted on the inflatable chamber 14a as it is positioned securely to the heel. The rear straps 54 should not be pulled so tightly that the nozzle 46 extending upward from the connecting section 50 is compressed.

Different embodiments of a foot bladder are seen in FIGS. 3D and 3E-3G. Foot bladder 14′ of FIG. 3D is shown crescent-shaped with inflatable chamber 14a′ and nozzle 46′. Foot bladder 14″ of FIGS. 3E-3G is shown as generally rectangularly shaped with inflatable chamber 14a″ and nozzle 46″ . The foot bladders 14′ and 14″ attach to the heel such that the bulk of each inflatable chamber 14a′, 14a″ is operably disposed underneath the heel and bottom of the foot. In such embodiments, the inflatable chamber is not divided into a compression section 48 and a connecting section 50 because most if not all of the inflatable chamber is compressed when the heel strikes the ground.

In all embodiments, the amount of fluid in the foot bladder is chosen so that the leg bladder can accommodate all of the fluid of the foot bladder when that fluid is forced out of the foot bladder by the walking motion. Preferably, the system is arranged such that the leg bladder generally applies a constant pressure of 30-40 mm Hg to a wound site, and when fluid is forced out of the foot bladder due to the walking motion, the pressure in the leg bladder is increased by an additional 10-20 mm Hg. While it is possible to tolerate higher intermittent pressures (e.g., 80 mm Hg), a maximum pressure of 50-60 mm Hg is preferred.

In the configurations of FIGS. 3A-3G, the fluid conduit 16 can be affixed to the inflatable chamber 14a′, 14a″ of the foot bladder 14′, 14″. Alternatively, the foot bladder 14′, 14″ can be provided with a nozzle or connector element 46′, 46″ which extends through the upper wall with a first end inside the inflatable chamber, and a second end outside of the inflatable chamber. The second end of the nozzle is preferably disposed behind the heel so that the nozzle 46′, 46″ will not be crushed by the foot in a standing position or during the walking motion.

As shown in FIGS. 3F and 3G, foot bladder 14″ may be provided with front and rear straps 52″, 54″, which are shortened (relative to the embodiment of FIGS. 3A-3C) and are provided with adhesive sections 66 located at the ends of the straps 52, 54 for attachment directly to the foot (or sock).

In the embodiments of the present invention in which the fluid conduit 16 is integrally formed with and permanently connected to the bladders 12, 14, the apparatus 10 is a closed system. Such embodiments do not require the pressurization of either of the bladders 12, 14 or of the fluid conduit 16 prior to their use. Rather, during the manufacturing process of apparatus 10, the ends 16a, 16b of the fluid conduit 16 are fluidly coupled to and form airtight seals with the inflatable chambers 12a, 14a. During the heat sealing of one or both of the inflatable chambers 12a, 14a, the amount of fluid trapped in the system is controlled. Alternatively, if a one-way valve/nozzle 68 as shown in FIG. 5 is provided, then after the fluid conduit 16 is permanently attached to the bladders 12, 14, pressurization of the apparatus 10 may take place by means of the one-way valve/nozzle 68. The one-way valve/nozzle 68 is used to pressurize the apparatus 10 to a desired pressure by connection to a fluid source such as an air pump. Once the desired pressure is reached (which may be below the ambient air pressure), the fluid source is removed from the one way valve 68, which closes. In such embodiments, nozzles 18, 46 are not necessary because the apparatus 10 is a closed system. Fluid flows freely between the bladders 12, 14 through the fluid conduit 16 (with the pressure in each of the bladders 12, 14 varying as the apparatus 10 is operated in the manner discussed below), but no additional fluid is allowed into the apparatus 10. The apparatus 10 is secured to the body by attaching the foot and leg bladders 14, 12 to the foot and leg as discussed herein. The one way valve 68 may alternatively be located on either of the inflatable chambers 12a, 14a of the bladders 12, 14 rather than on the fluid conduit 16.

In other embodiments, the fluid conduit 16 is detachably connected to the nozzles 18, 46 of the leg bladder 12 and foot bladder 14. In such embodiments, the ends 16a, 16b of the fluid conduit may be inserted through the nozzles 18, 46 to fluidly couple the leg bladder 12 with the foot bladder 14 in an airtight manner. The air-tight connection between the fluid conduit 16 and the nozzles 18, 46 may be accomplished by male and female threaded surfaces, bayonet locks, or other equivalent means known in the art. The nozzles 18, 46 may contain two way valves (not shown) for pressurizing either or both of the inflatable chambers 12a, 14a prior or subsequent to attaching the fluid conduit 16. The fluid conduit 16 is preferably made from rubber or plastic and by way of example and not by way of limitation has a diameter in the range of ¼ to ½ inch, a length in the range of two to twelve inches, and walls having a thickness in the range of ⅛ to ½ inch. This wall thickness is recommended to prevent or minimize expansion of the fluid conduit 16 as the pressure varies therein throughout the operation of the apparatus 10 (i.e., the tube preferably can withstand pressures of 60 mm Hg and above without expanding).

In embodiments in which the fluid conduit 16 is permanently attached to the bladders 12, 14, the apparatus 10 is assembled by simply attaching the foot and leg bladders 14, 12 to the foot and leg as described herein. No additional set-up is necessary.

In embodiments in which the fluid conduit 16 is detachably connected to the bladders 12, 14, the apparatus may be assembled by either first attaching the foot and leg bladders 14, 12 to the foot and leg, and then connecting the fluid conduit 16 to the nozzles 18, 46, or by first connecting the fluid conduit 16 to the foot and leg bladders 14, 12, and then connecting the foot and leg bladders 14, 12 to the foot and leg. In such embodiments, a fluid is supplied into either the inflatable chamber 12a of the leg bladder 12 or the inflatable chamber 14a of the foot bladder 14 (or both) through the nozzles 18, 46 from a fluid source such as an air pump. As fluid is supplied, the bladder(s) 12, 14 will inflate and pressurize. When the fluid source is removed from the nozzles 18, 46, the valves in the nozzles will maintain the pressure in each of the bladders 12, 14. The fluid conduit 16 may then be pinched at one of the two ends 16a, 16b while the other of the two ends 16a, 16b is coupled to one of the nozzles 18, 46. The fluid conduit 16 opens the valve within the nozzle as it enters therein. The pinched end of the fluid conduit 16 is then coupled to the other nozzle, which opens that nozzle's valve, and the apparatus 10 is then ready for operation. The fluid used inside of the apparatus 10 may be air, liquid, or a combination of both depending on the fluid source desired, the pressure desired, and the specific materials used.

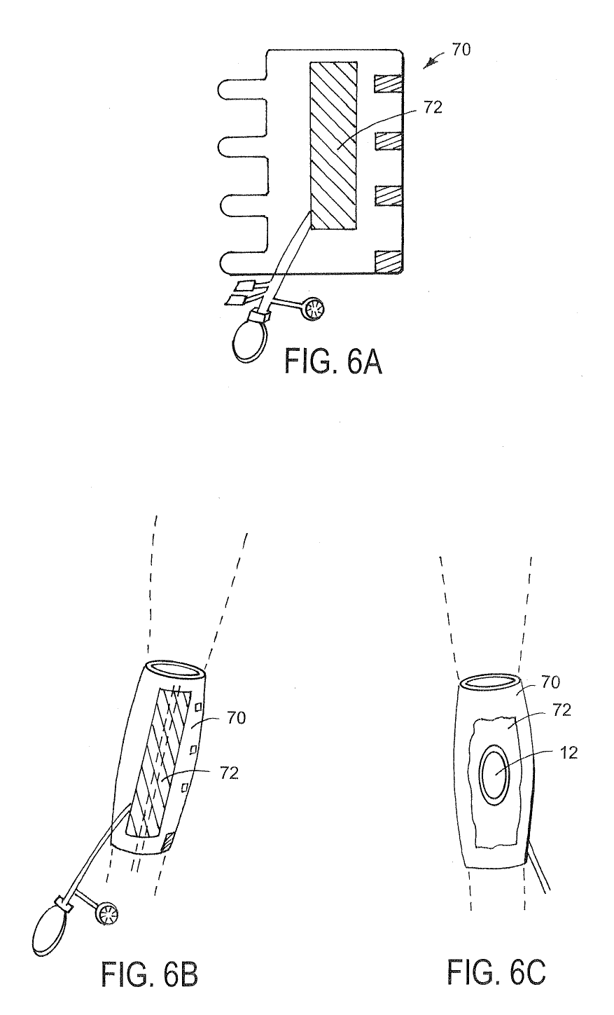

In yet another embodiment of the present invention, the leg bladder 12 is positioned on the leg by means of a flexible leg wrap apparatus 70 such as the one disclosed in the commonly owned U.S. Pat. No. 7,276,037, which has been incorporated by reference in its entirety. The leg wrap apparatus 70, shown in FIGS. 6A-6C, has an inflatable air bladder chamber 72 secured to a flexible wrap member 73. The flexible member 73 is designed to wrap around the leg in a wrapped configuration with the air bladder chamber 72 being operably disposed on an interior surface of the flexible member 73 such that the flexible member 73 exerts pressure over a large area of a leg. In this embodiment, no straps 32 or other attachment means need be connected to the leg bladder 12 because the flexible member 73 serves the dual function of positioning the leg bladder 12 on the leg (the leg bladder 12 being sandwiched between the inflatable air bladder chamber 72 and the leg) and providing additional pressure to other areas of the leg.

In one embodiment, the inflatable chambers 12a, 14a of the leg and foot bladders 12, 14 are prefilled such that when they are secured to the leg and foot and used in conjunction with the leg wrap apparatus 70, the leg wrap apparatus causes the leg bladder 12 to substantially deflate when a patient is lying down or has the foot elevated while walking (i.e. when the foot is not compressing the foot bladder 14). In such embodiments, it is preferred that the fluid displaced from the leg bladder 14 to the foot bladder 12 cause the inflatable chamber 12a of the foot bladder 12 to inflate to approximately one-half to three-quarters of its maximum volume. In these embodiments, the leg wrap apparatus 70 alone puts pressure on the saphenous vein of the patient while the patient is lying down or has his or her foot elevated. When the foot bladder 14 is compressed during the standard walking motion, fluid is displaced from the foot bladder 14 back to the leg bladder 12, increasing the pressure therein. This intermittent on and off compression will help to promote circulation to an ulcer bed disposed on the patient's leg underneath the leg bladder 12 and leg wrap apparatus 70.

The inflatable air bladder 72 is optionally provided with a pressure gauge and an automatic pressure relief valve coupled to the inflatable air bladder chamber 72 to vent air from the chamber 72 to the ambient environment when the internal pressure reaches a threshold maximum pressure. For example, the apparatus 10 may be attached to the leg and foot as described above in any of the embodiments. The flexible member 73 is then wrapped with tension around the leg and over the leg bladder 12 with the air bladder chamber 72 touching the inflatable chamber 12a and exerting a pressure thereon (FIG. 6C). If during operation of the apparatus 10, the pressure in the inflatable air bladder 72 becomes higher than the threshold maximum, then the automatic pressure relief valve releases air from the chamber 72, which reduces the tension in the flexible member 73.

The flexible leg wrap apparatus 70 may be used in conjunction with all embodiments of the apparatus 10 disclosed herein.

Once the apparatus 10 is assembled and fastened to a person as discussed above, the apparatus 10 operates as a person walks. During the standard heel to toe motion of walking, the compression section 48 of the foot bladder inflatable chamber 14a is squeezed between the heel and the ground, which puts external pressure on the compression section 48 forcing all or most of the fluid out thereof, (i.e. the compression section 48 of the inflatable chamber 14a of the foot bladder 14 deflates as a heel strikes the ground). Fluid is thus pushed Up through the connecting section 50 of the inflatable chamber 14a, into and through the fluid conduit 16, and up into the leg bladder 12. The inflatable chamber 12a of the leg bladder 12 inflates to accommodate the entering fluid. As the inflatable chamber 12a inflates, the sidewall 26 of the inflatable chamber 12a presses against the straps 32 of the leg bladder and/or the flexible member 73 of the leg wrap apparatus 70. The straps 32 and/or flexible member 73, which are securely fastened to the leg with tension and preferably extend over the top of the inflatable chamber 12a, provide resistance to the sidewall 26 flexing or bowing outward, which limits the volume increase of the inflatable chamber 12a. The additional fluid entering the inflatable chamber 12a thus causes an increase in the pressure therein. This increased pressure is transmitted through the lower wall 20 and/or bottom layer 30 to the leg.

When the person's foot rolls from heel to toe, the external pressure from the person's weight is removed from the heel. At that point, the pressure in the fluid conduit 16 and the inflatable chamber 12a of the leg bladder 12 is greater than the pressure in the inflatable chamber 14a of the foot bladder 14. Because in equilibrium the pressures will be equal, a portion of the fluid in the leg bladder 12 flows back through the fluid conduit 16 into the inflation chamber 14a of the foot bladder 14, which expands back to its original state, until the pressure therein equals the pressure in the leg bladder 12 and the fluid conduit 16. This process repeats as the person walks, which creates a pumping or kneading force on the wound area of the leg over which the leg bladder 12 is placed as the pressure in the leg bladder 12 increases and decreases, thereby promoting blood flow, drainage, treatment, and healing to various parts of the leg.

The pressure in the inflatable chamber 12a of the leg bladder 12 is impacted by a number of factors. It should be noted that if the leg bladder 12 is pressurized before placing it on the leg, then the pressure inside the inflatable chamber 12a will increase when it is placed on the leg prior to the straps 32 being secured because the volume of the inflatable chamber 12a decreases slightly as the lower wall 20 curves to conform to the shape of the leg. The straps 32 further increase the pressure on the inflatable chamber 12a as they are secured thereto. In addition, in embodiments in which the fluid conduit 16 is detachable, the pressure in the apparatus 10 may be varied by pressurizing one or both of the leg bladder 12 and foot bladder 14, or by using a longer or wider fluid conduit 16, which increases the internal volume of the apparatus 10. The pressure may also vary as a function of the tightness with which the straps 32 are wrapped around the leg and/or placed over the inflatable chamber 12a, and the tension with which the straps 52, 54 are wrapped around the foot and/or placed over the inflatable chamber 14a. For example, a greater tension of the straps 56 around the leg and/or inflatable chamber 12a of the leg bladder 12 produces a greater inwardly directed (minimum) compressive force on the leg. The operation of the apparatus 10 to inflate the inflatable chamber 12a will produce additional pressure on the leg as the inflatable chamber 12a inflates, encounters resistance from the straps 56, and continues to fill with fluid without a corresponding increase in volume.

There have been described and illustrated herein several embodiments of an intermittent pressure apparatus and a method of installing and operating same. While particular embodiments of the invention have been described, it is not intended that the invention be limited thereto, as it is intended that the invention be as broad in scope as the art will allow and that the specification be read likewise. Thus, while particular shapes and sizes of inflatable bladders and straps have been disclosed, it will be appreciated that other shapes, sizes, and attachment means may be used as well. It will also be understood that while Velcro and adhesive means have been disclosed for helping to secure the bladders to the leg and foot, other types of attachments such as hooks, snaps, or wraps may be used. In addition, it will be appreciated that while the fluid conduit may be detachably connected to the bladders using mating threaded portions or bayonet locks, other means of attachment known in the art may be used. It will therefore be appreciated by those skilled in the art that yet other modifications could be made to the provided invention without deviating from its spirit and scope as claimed.

What is claimed is:

1. An apparatus for applying pressure to a leg of the human body, comprising:
a foot bladder having a first inflatable chamber that accommodates a fluid entering therein by inflating;
a leg bladder having a second inflatable chamber that accommodates the fluid entering therein by inflating;
a first means for locating said leg bladder on the leg of the human body;
a second means for locating said foot bladder on a foot of the human body;
a fluid conduit fluidly coupling said foot bladder and said leg bladder such that a fluid may travel from said foot bladder to said leg bladder through said fluid conduit, and from said leg bladder to said foot bladder through said fluid conduit.

2. The apparatus of claim 1, wherein:
said first means for locating is a first attachment member wrapping around the leg to secure the leg bladder to the leg.

3. The apparatus of claim 2, wherein:
said first attachment member is a plurality of straps attached to said leg bladder.

4. The apparatus of claim 2, wherein:
said first attachment member is a flexible member wrapping around the leg and over said leg bladder wherein said leg bladder is sandwiched between the leg and said flexible member.

5. The apparatus of claim 1, wherein:
said second means for locating is a second attachment member wrapping around the foot to secure the fluid foot bladder to the foot.

6. The apparatus of claim 5, wherein:
said second attachment member is a plurality of straps attached to said foot bladder.

7. The apparatus of claim 6, wherein:
said plurality of straps have an adhesive for attaching said straps to the foot.

8. The apparatus of claim 1, wherein:
said foot bladder attaches to a bottom portion of a heel of the foot.

9. The apparatus of claim 4, wherein:
said first attachment member includes a secondary air bladder, said flexible member has an encircling configuration that wraps around the leg, and an open unwrapped configuration, and
said secondary air bladder is supported by said flexible member in said encircling configuration, said secondary air bladder capable of inflation to a pressurized state which supplies compressive forces that are directed radially inward to apply compressive forces to the leg when supported by said flexible member in said encircling configuration.

10. The apparatus of claim 1, wherein:
said fluid conduit has a length in the range of two to twelve inches.

11. The apparatus of claim 1, wherein:
said fluid is air.

12. The apparatus of claim 1, wherein:
said fluid is a liquid.

13. The apparatus of claim 1, wherein:
said foot bladder and said leg bladder are arranged such that when said fluid is forced out of said foot bladder, said leg bladder applies an extra pressure to the leg.

14. The apparatus of claim 13, wherein:
said extra pressure is between 10 and 20 , mm Hg extra pressure.

15. The apparatus of claim 14, wherein:
said leg bladder applies between 30 and 40 mm Hg pressure to the leg in a first state, and applies between 50 and 60 mm Hg pressure to the leg when fluid is forced out of said foot bladder.

16. The apparatus of claim 1, wherein:
said fluid conduit has a first end and a second end, and said leg bladder and said foot bladder each have a nozzle for receiving one of said first and second ends of said fluid conduit.

17. A method for applying pressure to a portion of a human body, comprising:
affixing a foot bladder to a bottom portion of a foot and a leg bladder to a leg, wherein said foot bladder and said leg bladder are fluidly coupled by a fluid conduit;
walking such that said foot bladder is depressed when the heel of a foot strikes the ground, forcing fluid out of said foot bladder, through said fluid conduit, and into said leg bladder, thereby raising the pressure in said leg bladder, wherein when the heel of the foot is raised, said foot bladder is inflated as fluid is forced out of said leg bladder, through said fluid conduit, and into said foot bladder.

18. The method of claim 17, wherein:
said foot bladder includes a plurality of straps for attaching said foot bladder to the foot.

19. The method of claim 17, wherein:
said leg bladder includes a first nozzle, said foot bladder includes a second nozzle, and said affixing further includes attaching said fluid conduit to said first and second nozzles.
